(19) United States
(12) Patent Application Publication
(10) Pub. No.: US 2026/0369283 A1
(43) Pub. Date: Nov. 19, 2026

(54) SYSTEMS AND METHODS FOR IMPROVING CONFERENCE AUDIO TRANSMISSION

(71) Applicant: Adeia Guides Inc., San Jose, CA (US)

(72) Inventors: Tao Chen, Palo Alto, CA (US); Christopher Phillips, Hartwell, GA (US); Mathew Adams, Matthews, NC (US)

(21) Appl. No.: 19/210,008

(22) Filed: May 16, 2025

(51) Int. Cl. G10L 19/012; G06V 20/40; G06V 40/20; G10L 25/51; G11B 27/031; H04L 65/403

(52) U.S. Cl. CPC G10L 19/012; G06V 20/41; G06V 40/20; G10L 25/51; G11B 27/031; H04L 65/403

(57) ABSTRACT

Systems and methods are provided for enabling the improved transmission of audio in a digital audio exchange. Voice chat audio is captured as voice chat audio data at a first computing device of a plurality of computing devices participating in a digital audio exchange. The voice chat audio data is processed, including simultaneously encoding the voice chat audio data for transmitting and performing a relevance analysis of the voice chat audio. A control signal is generated based at least in part on the relevance analysis. The control signal and the encoded voice chat audio data are transmitted by the first computing device for reception by a second computing device of the plurality of computing devices, to cause the second computing device to select, based on the control signal, a subset of the transmitted voice chat audio data and to output audio based on the selected subset of the audio data.

The present disclosure is generally directed to systems and methods for enabling the improved transmission of audio in a digital audio exchange.

### SUMMARY

Conferences, such as videoconferences, audio conferences and/or phone calls, are a popular way for information to be relayed to groups of people and for groups of people to discuss ideas. Typically, a conference participant joins a conference via a computing device such as a smartphone, laptop or dedicated conference device. These devices typically comprise a microphone for capturing and relaying audio to other conference participants, and a speaker for outputting audio from the other conference participants. Where the devices are used for a videoconference, the devices may also comprise a camera and a screen. In such conferences, there may be instances where sound unrelated to an ongoing presentation or discussion is captured at a device participating in the conference, and the sound is broadcast to the other conference devices. Examples of these unrelated sounds include background sounds or a conversation local to a user that is not relevant to the conference. Outputting sounds at conference devices that are unrelated to an ongoing conference discussion may reduce the quality of the conference for the conference participants. One way of addressing this problem is to locally identify and filter out unwanted sounds from the audio of a conference call before it is transmitted from a local device; however, this approach may increase latency due to the detection of the unwanted sounds and the processing of the audio before it is transmitted from the local device. That is, in this linear approach, the transmitting device performs a linear process that includes: (i) receiving audio, (ii) analyzing and processing the audio to identify a first subset of the audio to transmit and a second subset of the audio to filter; (iii) encoding and packetizing only the first subset of the audio; and (iv) transmitting the encoded and packetized first subset of audio. Because the transmitter transmits only the first subset, any time spent analyzing and processing the initial audio to identify which audio to send and which to filter necessarily delays transmission. In an example process, this could double or triple the latency experienced in uploading relevant audio. For example, while the transmitter might be able to encode, packetize, and send unfiltered audio with a latency of roughly 30 ms (i.e., with the latency caused by encoding, packetizing, and sending), the introduction of the filtering processing may increase the latency to 50-200 ms. This extra latency can be problematic in some contexts, in particular, for example, when a conference is interactive. For example, latency of 150 ms or more can result in noticeable delays (and degraded user experience) for video conference applications. In cloud gaming, a latency of under 20 ms is sometimes considered ideal, and a latency of over 50 ms can result in significantly degraded user experiences.

To help address these problems, systems and methods are provided herein that enable the improved transmission of audio in a digital audio exchange. In particular, the audio transmission in the digital audio exchange is improved by utilizing a control signal to process conference audio at a receiving computing device, thereby reducing the latency associated with processing conference audio at a transmitting computing device, before the audio is transmitted.

In accordance with some aspects of the disclosure, a first method is provided. In an embodiment, the method includes capturing voice chat audio as voice chat audio data at a first computing device of a plurality of computing devices participating in a digital audio exchange. The voice chat audio data is processed, including simultaneously encoding the voice chat audio data for transmitting and performing a relevance analysis of the voice chat audio, and a control signal is generated based at least in part on the relevance analysis. The control signal and the encoded voice chat audio data are transmitted by the first computing device for reception by a second computing device of the plurality of computing devices, to cause the second computing device to select, based on the control signal, a subset of the transmitted voice chat audio data and to output audio based on the selected subset of the transmitted voice chat audio data.

In an example system, a user joins a video conference via a laptop. As the user speaks, a microphone at the laptop captures spoken audio from the user and background noise relating to construction works. The laptop simultaneously transmits the audio to other conference participants and analyzes the spoken audio. At the laptop, the background noise relating to the construction works is identified, and a control signal is generated for removing the construction works from the captured audio. This control signal is also transmitted to the other conference participants. The audio and the control signal are received at computing devices being used by the other conference participants, and those computing devices use the control signal to remove the parts of the audio relating to the construction works. In this manner, the delay associated with transmitting the audio to the other conference participants is utilized to analyze the audio and generate a control signal. This control signal is utilized at the receiving computing devices to selectively output the received audio, thereby reducing the latency associated with removing unwanted noises from conference audio.

### BRIEF DESCRIPTIONS OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

The above and other objects and advantages of the disclosure may be apparent upon consideration of the following detailed description, taken in conjunction with the accompanying drawings, in which:

FIG. 1 shows an example environment for enabling the improved transmission of audio in a digital audio exchange, in accordance with some embodiments of the disclosure;

FIG. 2 is a schematic diagram showing additional delay introduced by analysis and filtering;

FIG. 3 shows another example environment for enabling the improved transmission of audio in a digital audio exchange, in accordance with some embodiments of the disclosure;

FIG. 4 shows another example environment for enabling the improved transmission of audio in a digital audio exchange, in accordance with some embodiments of the disclosure;

FIG. 5 shows another example environment for enabling the improved transmission of audio in a digital audio exchange, in accordance with some embodiments of the disclosure;

FIG. 6 is a flowchart of illustrative steps for enabling the improved transmission of audio in a digital audio exchange, in accordance with some embodiments of the disclosure;

FIG. 7 is another flowchart of illustrative steps for enabling the improved transmission of audio in a digital audio exchange, in accordance with some embodiments of the disclosure;

FIG. 8 is another flowchart of illustrative steps for enabling the improved transmission of audio in a digital audio exchange, in accordance with some embodiments of the disclosure;

FIG. 9 is another flowchart of illustrative steps for enabling the improved transmission of audio in a digital audio exchange, in accordance with some embodiments of the disclosure; and

FIG. 10 is a block diagram representing components of a computing device and dataflow therebetween for enabling the improved transmission of audio in a digital audio exchange, in accordance with some embodiments of the disclosure.

### DETAILED DESCRIPTION

A digital audio exchange includes any digital audio exchange between two or more computing devices. It may include, for example, an audio conference and/or a gaming session. In some examples, the digital audio exchange may be part of a video conference. Audio input may be captured by a microphone that is integral to a computing device or a microphone that is removably connected to the computing device.

In some examples, simultaneously encoding voice chat audio data for transmitting and performing a relevance analysis of the voice chat audio includes simultaneously encoding the entirety of the voice chat audio data and performing the entirety of the relevance analysis of the voice chat audio. In other examples, simultaneously encoding voice chat audio data for transmitting and performing a relevance analysis of the voice chat audio includes simultaneously encoding a portion of the voice chat audio data and performing a portion of the relevance analysis of the voice chat audio.

A control signal includes any data that enables a computing device to selectively output received audio data.

The disclosed methods and systems may be implemented on one or more devices, such as user or client devices, servers, network management or other network devices, and/or other computing devices. As referred to herein, the device can be any device comprising a processor and memory, for example, a conference speakerphone, a handheld computer, a mobile telephone, a portable video player, a portable music player, a portable gaming machine, a smartphone, a smart television, a smartwatch, a smart speaker, an augmented reality headset, a mixed reality device, a virtual reality device, a gaming console, a vehicle infotainment headend or any other computing equipment. Typically, a computing device will also comprise a network interface.

The methods and/or any instructions for performing any of the embodiments discussed herein may be encoded on computer-readable media. Computer-readable media includes any media capable of storing data. The computer-readable media may be transitory, including, but not limited to, propagating electrical or electromagnetic signals, or may be non-transitory, including, but not limited to, volatile and non-volatile computer memory or storage devices such as a hard disk, USB drive, DVD, CD, media card, register memory, processor cache, random access memory (RAM) and/or a solid-state drive.

### DETAILED DESCRIPTION

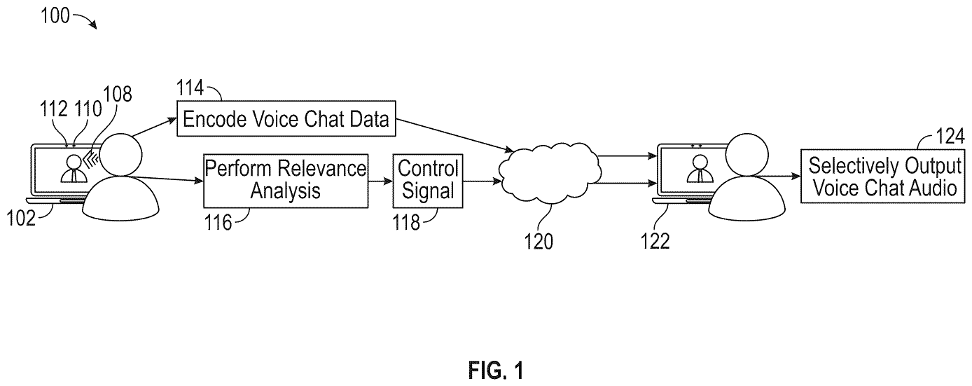

FIG. 1 shows an example environment for enabling the improved transmission of audio in a digital audio exchange, in accordance with some embodiments of the disclosure. The environment 100 comprises a first computing device, in this example a first laptop 102, a network 120 and a second computing device, in this example, a second laptop 122. The first laptop 102 transmits and receives data via the network 120, which may be any suitable network, such as the internet, to the second laptop 122. The network 120 may comprise wired and/or wireless means. In this example, the first and second laptops 102, 122 are participating in a video conference; however, in other examples, the first and second laptops 102, 122 may participate in any suitable digital audio exchange including, for example, an audio-only conference, or call and/or an audio call as part of a gaming session. Although this example depicts two computing devices, any suitable number of computing devices may participate in a digital audio exchange including, for example, five, 20, 100, 500 and/or 1000 computing devices.

A first user speaks, and audio 108 from the first user is captured by, for example, a microphone 110 integral to the first laptop 102 as voice chat audio data. In this example, a camera 112 is utilized to capture and transmit video of the video conference to the second laptop 122, where it is displayed. The voice chat audio data is simultaneously encoded 114 for transmitting and a relevance analysis is performed 116. In some examples, simultaneously encoding 114 voice chat audio data for transmitting and performing 116 a relevance analysis of the voice chat audio includes simultaneously encoding 114 the entirety of the voice chat audio data and performing 116 the entirety of the relevance analysis of the voice chat audio. In other examples, simultaneously encoding 114 voice chat audio data for transmitting and performing 116 a relevance analysis of the voice chat audio includes simultaneously encoding 114 a portion of the voice chat audio data and performing a portion of the relevance analysis of the voice chat audio. A control signal 118 is generated based, at least in part, on the relevance analysis. In some examples (not shown), the voice chat audio data may be transmitted from the first laptop 102, via network 120, to one or more servers, and steps 114, 116 and 118 may take place at the one or more servers. In another example, step 114 may take place at the first laptop 102, and steps 116 and 118 may take place at the one or more servers.

The control signal and the encoded voice chat audio data are transmitted via the network 120 to the second laptop 122, where the second laptop selects, based on the control signal, a subset of the transmitted voice chat audio data and outputs, based on the selected subset of the transmitted voice chat audio data, audio. The control signal is utilized by another computing device, in this example, the second laptop 122, to identify which parts of the encoded voice chat data to generate for output, without requiring the computing device to perform a relevance analysis of received audio data. In this manner, the time taken to encode the voice chat audio data at a transmitting computing device, such as the first laptop 102, may be utilized to perform a relevance analysis in parallel, thereby reducing the latency associated with analyzing voice chat audio data and determining which parts to output and which parts to discard. In some examples, the control signal may be utilized by the second laptop 122 to alter the audio for output.

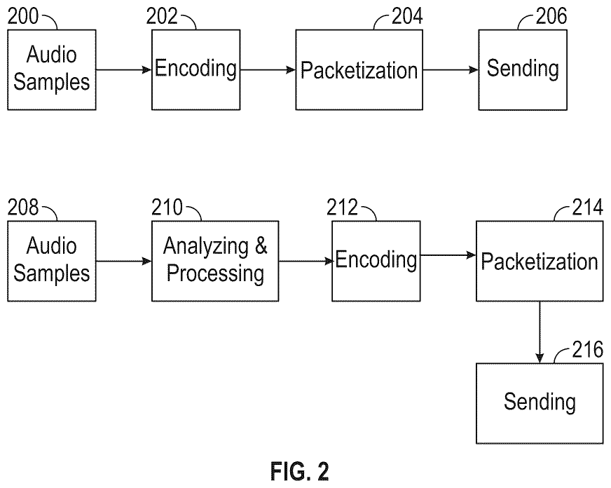

FIG. 2 is a schematic diagram showing additional delay introduced by analysis and filtering. At step 200, one or more audio samples are received by a first computing device; at step 202, the one or more audio samples are encoded; at step 204, the encoded one or more audio samples are packetized; and at step 206, the packetized one or more audio samples are sent to a second computing device. At step 208, the same process is performed; however, at step 210, the one or more audio samples 208 are analyzed and processed. The one or more audio samples are received by the first computing device; at step 210, the one or more audio samples are analyzed and processed; at step 212 the one or more audio samples are encoded; at step 214, the encoded one or more audio samples are packetized; and at step 216, the packetized one or more audio samples are sent to a second computing device. As the steps 208-216 are performed serially, any delay introduced by the analyzing and processing at step 210 directly impacts the time it takes to transmit the encoded and packetized one or more audio samples.

In, for example, video conferencing, a latency of 150 ms or less may be desirable, and higher latency values may result in noticeable delays. In another example, in cloud gaming, a latency under 20 ms is typically considered desirable for a responsive experience, while a latency between 20 ms and 50 ms may be adequate. When the latency exceeds 50 ms, the quality of experience may become unacceptable for many games, in particular for games of the genre of first person shooter.

With a same network connection, it is feasible to achieve a latency of 20 ms in cloud gaming, meanwhile accommodating video conferencing with an acceptable 150 ms latency. Therefore, it may be practicable to take advantage of the difference in latency requirements, e.g., 130 ms, to apply detection and analysis to generate a control signal, and to then transmit the control signal to enable the management of the playback of a delivered audio or voice segment of a conference. Quick user datagram protocol internet connection (QUIC) is an example of a protocol that may enable the delivery of multiple streams of different priorities over a same network connection. QUIC enables, for example, a fast handshake, stream multiplexing to remove head-of-line blocking observed in single stream, and flexible congestion control.

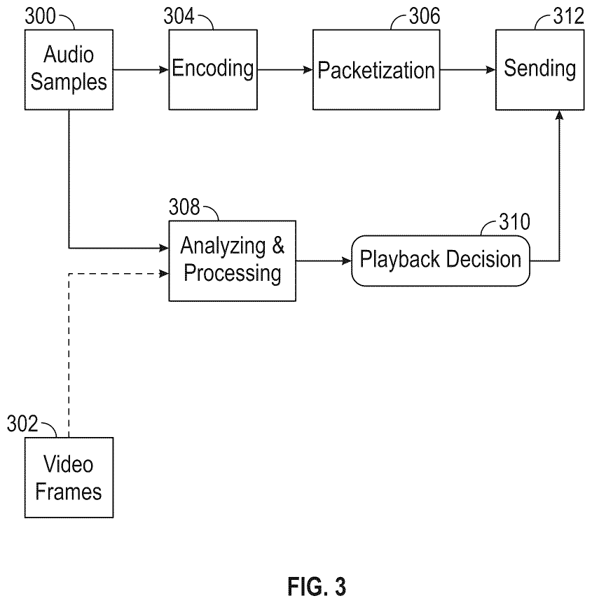

FIG. 3 shows another example environment for enabling the improved transmission of audio in a digital audio exchange, in accordance with some embodiments of the disclosure. At step 300, one or more audio samples, for example, voice chat audio data, are received by a first computing device and, at step 302, one or more video frames are optionally received by the first computing device. In an audio-only conference, no video frames would be received. In a gaming session, the video frames may be video frames of a video game. At step 304, the one or more audio samples are encoded, and, at step 306, the encoded one or more audio samples are packetized. In parallel (or simultaneously) to steps 304 and 306, the one or more audio samples are analyzed and processed at step 308 and at step 310, a playback decision is made based on the analyzing and processing that took place at step 308, and a control signal is generated. At step 312, the packetized one or more audio samples and the control signal are sent to a second computing device.

The process shown in FIG. 3 enables a reduction in the latency caused by analyzing and filtering the one or more audio samples. The latency in the pipeline of encoding and packetizing is maintained while the analysis is running in parallel. The playback decision of audio frames may be subject to, for example, late binding in creating of the packets that are ready for sending. This late binding introduces a reduced delay (or latency) as the late binding needs to set and/or alter fields for signaling only when required. In some examples, the playback decision may comprise signaling of how the audio samples or frames may be altered at playback at the second computing device, i.e., it does not need to be limited to a simple binary (play or do not play) decision. The analysis and detection of relevance may include other modalities such as video, which may provide a useful assistance in speech analysis and detection. In some examples, a participant turning their head away and/or changing gaze from the normal positions in an associated video may be identified as a trigger to detect the relevance and/or irrelevance, if there is audio or speech associated with the change.

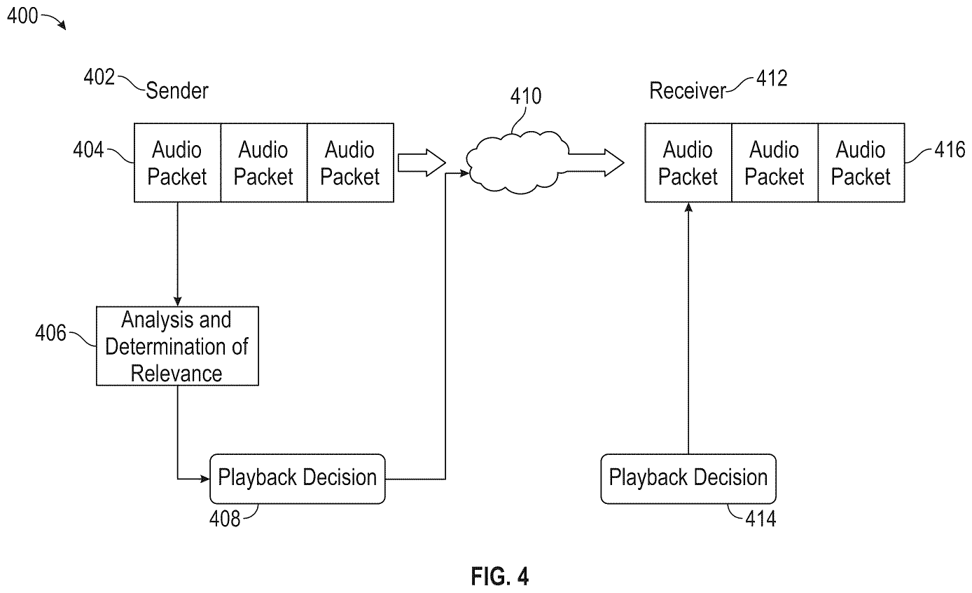

FIG. 4 shows another example environment for enabling the improved transmission of audio in a digital audio exchange, in accordance with some embodiments of the disclosure. The environment 400 comprises a sending computing device 402 and a receiving computing device 412. A first plurality of audio packets 404, for example, voice chat audio data packets, are transmitted from the sending computing device 402, via a network 410, such as the internet, to the receiving computing device 412. At step 406, an analysis and determination of the relevance of each audio packet of the first plurality of audio packets 404 is made and, based on this analysis and determination, a playback decision 408 is made for each packet of the first plurality of packets 404. A control signal is generated based on the playback decision 408, and the control signal is transmitted via network 410 to the receiving computing device 412. The received control signal is processed at the receiving computing device 412, where it is used to generate the playback decision 414 at the receiving computing device 412. The playback decision 414 is used to select which audio packets of the plurality of audio packets 416 received at the receiving computing device to utilize to generate audio for output at the receiving computing device.

In FIG. 4, there are asymmetric latencies in delivering the audio data and delivering the control signal; the transmission of the audio packets and control signal may be prioritized to enable the control signal to be delivered at a lower latency.

When a system or network is capable of supporting, for example, 20 ms latency for video conferencing, the system may also force and/or emulate a longer latency as long as it is within, for example, 150 ms for an acceptable quality of experience. For example, upon detecting multiple conversations, the received audio data (and, optionally, video data) may be buffered to simulate a delayed playback in anticipation of the time it may take to process the audio data to generate a control signal. In some examples, a side channel or link of low latency may be utilized to transmit the signaling of playback decisions (i.e., the control signal).

In some examples, the control signal may first signal the audio data, such as voice chat audio data, to be playable when received. In another example, a field of “later control” may be utilized to anticipate later control signal data to guide the playback. Such signaling may depend on the detection of possible ambiguity at the time of transmitting the audio data. If a confidence level is low, the audio packets may be signaled as “to be determined” for playback in the control signal. A default mode of processing and outputting “undetermined” packets may be a system setting and/or a user configuration at a receiving computing device. This may account, for example, for a scenario when the control signal arrives late (i.e., after (or substantially after) the audio data is received at a receiving computing device). In the event of a late arrival of a control signal, the receiving computing device may then default to a configured (or preset) mode. In some examples, if the audio comprises only one conversation, the audio packets may all be signaled as normal, or played upon reception.

In some examples, a control signal may indicate an altered playback of audio in addition to, or alternatively to, a binary indication of to play or not to play audio at a receiving computing device. Where a control signal indicates that a subset of audio packets should not be output at a receiving computing device, if there is an associated video (e.g., in the example of a video conference), the video of the corresponding duration may be subject to alteration so that user facial expressions and/or lip movement may appear more natural. In an example, this may comprise altering facial expressions and/or lip movements to show a user not speaking, if the corresponding audio is indicated as not to be selected for output at the receiving computing device).

The packet mentioned in connection with FIG. 4 may be an audio packetized elementary stream (PES) packet and not a transport packet. In some examples, there is typically a one-to-one mapping of an audio frame to a PES packet; however, multiple transport packets may be required to transport a single audio PES packet.

The systems and methods discussed herein, for enabling the improved transmission of audio in a digital audio exchange may be implemented and enabled on a client and/or server. A server may, for example, demultiplex audio (and/or video) streams, re-multiplex audio (and/or video) streams and/or transcode audio (and/or video) streams to different bitrates. The signaling of a playback status may be preserved and/or carried over in a relay. In some examples, an unspecified field and/or value in a header for signaling may be utilized as part of a control signal. In other examples, additional fields, e.g., through supplemental enhancement information (SEI), key-length-value (KLV) or moving picture experts group 7 (MPEG 7) metadata, may be utilized as part of a control signal.

In some examples, the determination to derive the control signal may be overridden by a user setting, for example, when a conference is being recorded. A speaking participant may later review and override a decision reflected in a control signal to prevent the output of audio if, for example, conference audio is considered relevant and/or useful to a discussion in the conference. A new presentation after changing the playback status may then be made available for downloading to other computing devices. In another example, if a user finds mis-detection, reflected in a control signal enabling audio output, there may also be the choice of overriding the control signal, for example, changing “play” to “do not play.” Such feedback may be utilized to improve the detection performance through, for example, reinforcement learning.

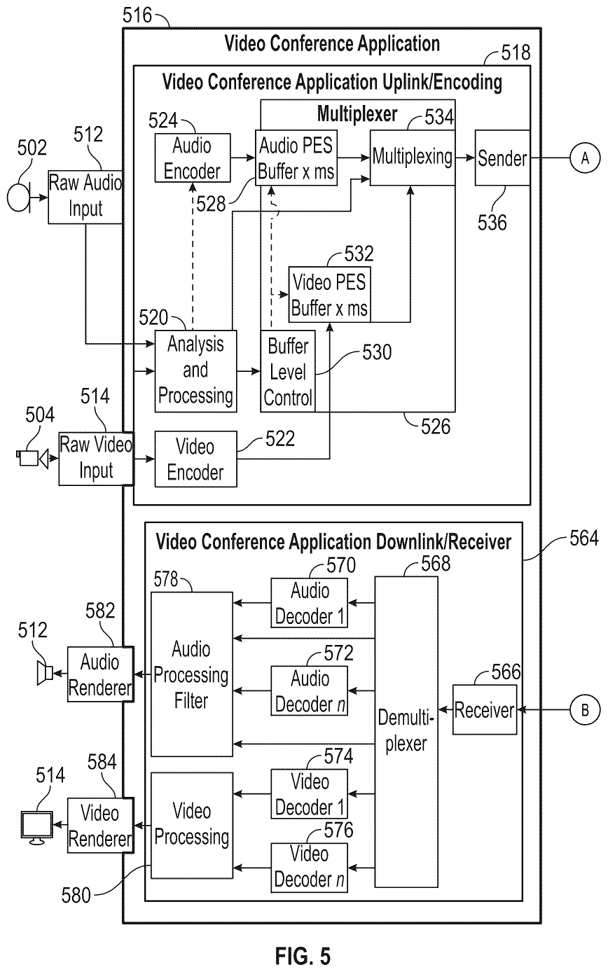

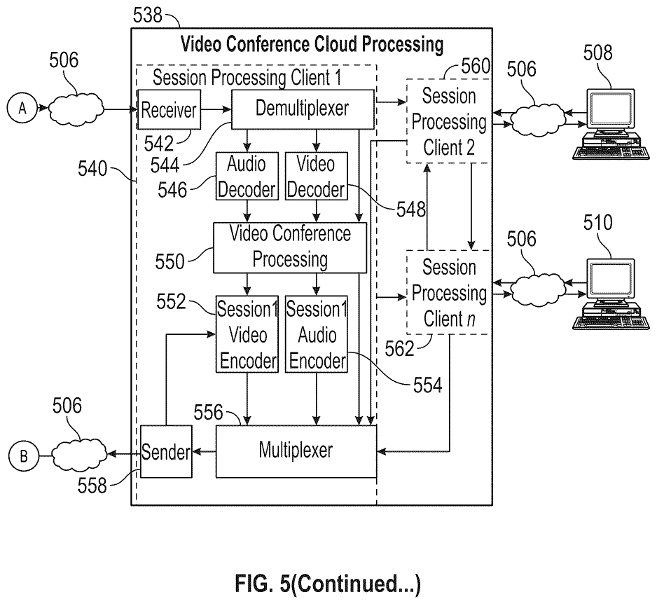

FIG. 5 shows another example environment for enabling the improved transmission of audio in a digital audio exchange, in accordance with some embodiments of the disclosure. The environment 500 comprises a microphone 502, for example, integral to a first computing device (not shown); an optional video camera 504, for example, integral to the first computing device; a network 506, such as the internet; a second computing device, such as a first laptop 508; a third computing device, such as a second laptop 510; a speaker 512, for example, integral to the first computing device; and a display 514, for example, integral to the first computing device.

Audio is captured at the microphone 502, and raw audio input 512 is transmitted from the microphone 502 to a video conferencing application 516. At a video conference application uplink/encoding module 518, the raw audio is received at an analysis and processing module 520. At the same time, video is optionally received at the video camera 504, and raw video input 514 is transmitted from the video camera 504 to the video conferencing application 516. At the video conference application uplink/encoding module 518, the raw video is also received at the analysis and processing module 520.

The raw audio is optionally transmitted from the analysis and processing module 520 to an audio encoder 524, which generates an audio PES. At the multiplexer module 526, the audio PES is transmitted to an audio PES buffer module, with a buffer size of x ms. The output of the analysis and processing module 520, for example, MEPG 7 audio analysis and playback metadata, is transmitted to a multiplexing module 534 of the multiplexer module 526. Data is also transmitted from the analysis and processing module 520 to a buffer level control module 530 of the multiplexer module 526. A buffer size of x ms is determined at the buffer level control module 530, and this buffer size is transmitted to the audio PES buffer module 528 and a video PES buffer module 532. The video PES buffer module 532 also receives a video PES from the video encoder 522. An audio PES delay of x ms is transmitted from the audio PES buffer module 528 to the multiplexing module 534, and a video PES delay of x ms is transmitted from the video PES buffer module 532 to the multiplexing module 534. Multiplexed audio, video and a control signal, for example, MPEG 7 metadata, for a first session are transmitted from the multiplexing module 534 to a sender module 536, which transmits the multiplexed audio, video and a control signal via the network 506 to a video conference cloud processing module 538 located, for example, at a server.

A receiver module 542 of a first session processing client module 540 at the video conference cloud processing module 538 receives the multiplexed audio, video and control signal for the first session. The receiver transmits the multiplexed audio, video and control signal to a demultiplexer module 544. An audio PES is transmitted from the demultiplexer module 544 to an audio decoder module 546, a video PES is transmitted from the demultiplexer module 544 to a video decoder module 548, and the control signal is transmitted from the demultiplexer module 544 to a video conference processing module 550. The video conference processing module 550 also receives raw audio from the audio decoder module 546 and raw video from the video decoder module 548.

Raw video is transmitted from the video conference processing module 550 to a first session video encoder module 552, and raw audio is transmitted from the video conference processing module 550 to a first session audio encoder module 554. A first session video PES is transmitted from the video encoder module 552 to a multiplexer module 556, and a first session audio PES is transmitted from the audio encoder module 554 to the multiplexer module 556. The multiplexer module 556 also receives the control signal from the video conference processing module 550.

The first session control signal, raw audio and raw video are transmitted from the first session processing client 540 to a second session processing client module 560. The second session client module 560 transmits multiplexed audio, video and a control signal from all of the other sessions to the first laptop 508 via the network 506, and the second session client module 560 receives second session multiplexed audio, video and a control signal from the first laptop 508 via the network 506. The second session control signal, raw audio and raw video are transmitted from the second session processing client module 560 to the multiplexer 556 and to the other session processing client module(s) 562. In a similar manner, the first session control signal, raw audio and raw video are transmitted from the first session processing client 540 to each of the other session processing client module(s) 562 (only one shown in this example) for each of the other conference participant(s). Each of the other session client module(s) 562 transmits multiplexed audio, video and a control signal from each of all of the other sessions to each of a corresponding second laptop 510 and any additional computing devices as appropriate for the number of conference participants via the network 506. Each of the other session client module(s) 562 receives session multiplexed audio, video and a control signal from the second laptop 510 and any additional computing devices as appropriate for the number of conference participants via the network 506. The session control signal, raw audio and raw video are transmitted from each of the other session processing client module(s) 562 to the multiplexer 556 and to any other session processing client module(s). The multiplexed audio, video and control signal from all of the sessions are transmitted from the multiplexer module 556 to a sender module 558. A bitrate control signal is transmitted from the sender module 558 to the first session video encoder 552.

The multiplexed audio, video and control signal from all of the session are transmitted from the sender module 558, via network 506, to a receiver module 566 of a video conference application downlink/receiver 564 of the video conference application 516. The receiver module 566 transmits the received multiplexed audio, video and control signal from all of the sessions to a de-multiplexer module 568, where audio PESs and video PESs are transmitted to respective audio decoders 570, 572 and video decoders 574, 576 for each of the sessions. Control signals for each of the sessions are transmitted from the demultiplexer 568 to an audio processing filter 578, which also receives output from the audio decoders 570, 572. Output from the video decoder modules 574, 576 is received at a video processing module 580.

Filtered raw audio is transmitted from the audio processing filter 578 to an audio renderer 582, which renders the audio, and the rendered audio is output at the speaker 516. Processed raw video is transmitted from the video processing module 580 to a video renderer 584, which renders the video, and the rendered video is output at the display 514.

FIG. 5 is an example of an end-to-end conferencing system. On each client computing device in a conference session, a calculated processing latency is sent to the multiplexer module 526 from the audio and video analysis and processing module 520. This latency may be a static (e.g., a maximum allowance for acceptable experiences) value at startup of the conferencing system and may remain consistent throughout the conference session. The latency value may be used to set audio and video PES packet buffer sizes in the multiplexer module 526 to enable the multiplexed packets to remain synchronized, and to allow for the processing time of the analysis and processing module 520. A control signal, in some examples, MPEG-2 multiplexed audio analysis and MPEG-7 playback metadata, is transmitted from the analysis and processing module 520 to the multiplexer module 526. In some examples, if this processing lags the initial calculated value, the data may not be transmitted to the multiplexer module 526 from the analysis and processing module 520. In this example, one or more default settings (e.g., set by the system and/or by a user pre-configuration) may be applied. The audio, video and control signal (such as MPEG 7 analysis metadata) may be multiplexed, and data for that session may be transmitted to a video conference processing cloud system module 538.

The video conference processing cloud system module 538 may also receive the same incoming multiplexed data from all other session participants 508, 510. For each of the sessions, the incoming multiplexed audio, video and control signal (such as MPEG 7 metadata) may be demultiplexed, and the audio and video may be decoded. The decoded audio, video and control signal may be utilized to perform additional processing on the raw audio, raw video and control signal. Each session may receive all the video conference processed raw video, raw audio and control signal. The raw video and raw audio of each session may be encoded independently by dedicated video and audio encoders (not shown) for the session, and may be multiplexed with the corresponding control signal for the session into a multi program MP2TS, which may be delivered to a corresponding client computing device.

Each client device will receive a multi program MPEG-2 transport stream (MP2TS), which may be demultiplexed for each session. The video streams that are demultiplexed from each session may be decoded and rendered. Each demultiplexed audio stream along with a corresponding control signal may be transmitted to an audio processing filter 578, where the filter will perform the actions as defined in the corresponding control signal. The audio processing filter 578 may apply the definitions to the incoming audio streams based on the control signal. An audio stream or multiple audio streams may be filtered at the same time based on, for example, a level of background noise. The control signal may comprise a start time and stop time for filtering an incoming audio stream. The control signal may include, for example, a complete audio mute from an audio stream, which may cause the audio processing filter 578 to completely mute the audio for the duration of time between the start time and the stop time. In some examples, the control signal may comprise data indicating the lowering of a volume for an audio stream by a defined level for the start time to the stop time. In another example, the control signal may also comprise data indicating the filtering of certain frequencies for a duration of time between the start time and the end time. In some examples, the metadata may also comprise a noise cancelation filter for a defined and/or an identified noise between the start time and the end time.

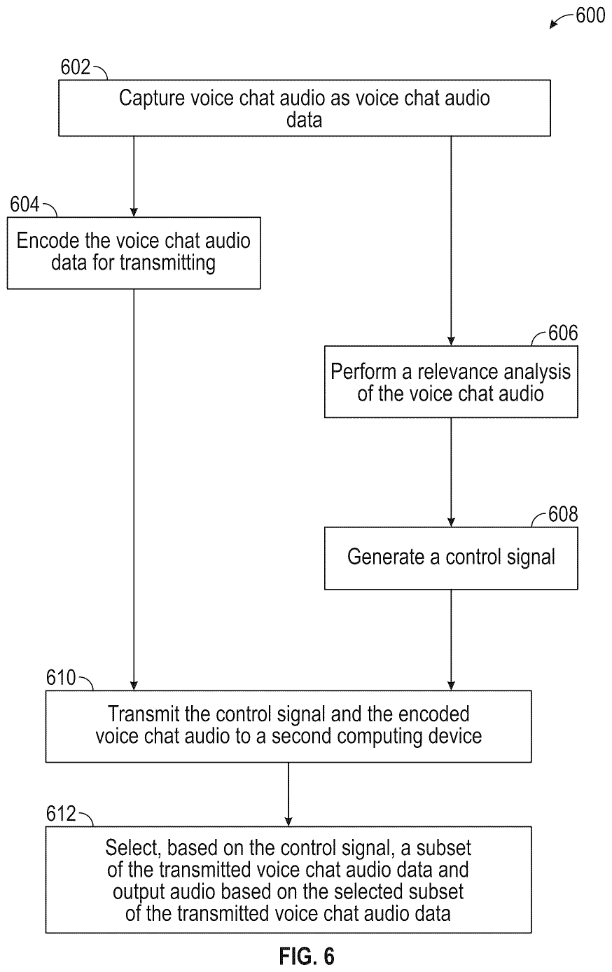

FIG. 6 is a flowchart of illustrative steps for enabling the improved transmission of audio in a digital audio exchange, in accordance with some embodiments of the disclosure. Process 600 may be implemented, in whole or in part, on any of the computing devices mentioned herein. In addition, one or more actions of the process 600 may be incorporated into or combined with one or more actions of any other processes or embodiments described herein.

At step 602, voice chat audio is captured as voice chat audio data, for example, at a first computing device of a plurality of computing devices participating in a digital audio exchange. At steps 604 and 606, the voice chat audio data is processed, including simultaneously encoding the voice chat audio data for transmitting at step 604, and performing a relevance analysis of the voice chat audio at step 606. In some examples, simultaneously encoding voice chat audio data for transmitting and performing a relevance analysis of the voice chat audio includes simultaneously encoding the entirety of the voice chat audio data and performing the entirety of the relevance analysis of the voice chat audio. In other examples, simultaneously encoding voice chat audio data for transmitting and performing a relevance analysis of the voice chat audio includes simultaneously encoding a portion of the voice chat audio data and performing a portion of the relevance analysis of the voice chat audio. At step 608, a control signal is generated based at least in part on the relevance analysis.

At step 610, the control signal and the encoded voice chat audio data are transmitted, by the first computing device, for reception by a second computing device of the plurality of computing devices. At step 612, the transmittal to the second computing device causes the second computing device to select, based on the control signal, a subset of the transmitted voice chat audio data and to output, based on the selected subset of the transmitted voice chat audio data, audio.

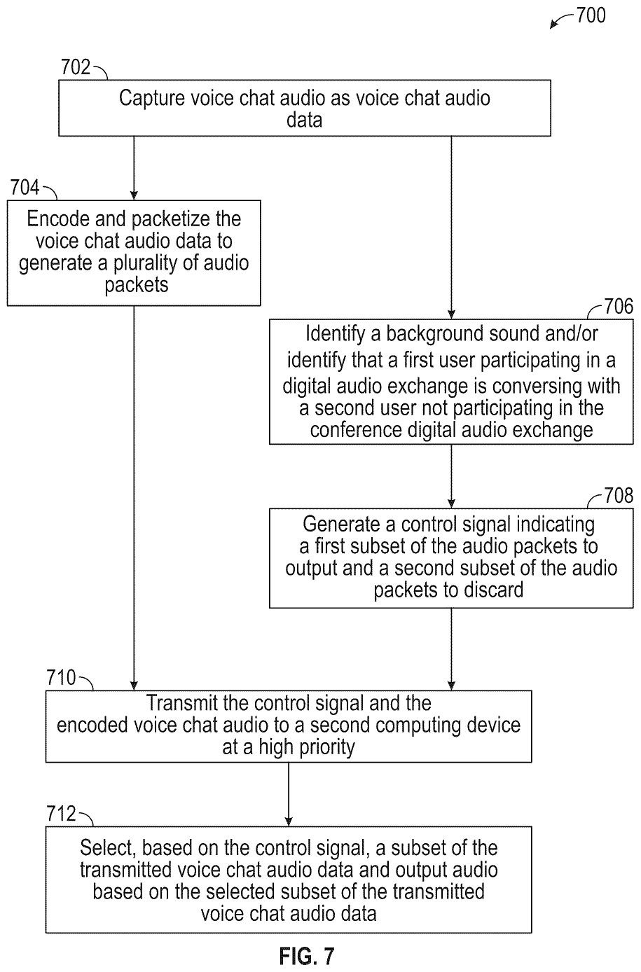

FIG. 7 is another flowchart of illustrative steps for enabling the improved transmission of audio in a digital audio exchange, in accordance with some embodiments of the disclosure. Process 700 may be implemented, in whole or in part, on any of the computing devices mentioned herein. In addition, one or more actions of the process 700 may be incorporated into or combined with one or more actions of any other processes or embodiments described herein.

At step 702, voice chat audio is captured as voice chat audio data, for example, at a first computing device of a plurality of computing devices participating in a digital audio exchange. At steps 704 and 706, the voice chat audio data is processed, including simultaneously encoding and packetizing the voice chat audio data to generate a plurality of audio packets for transmitting at step 704, and identifying a background sound and/or identifying that a first user participating in a digital audio exchange is conversing with a second user not participating (or not conversing with other participants) in the conference digital audio exchange at step 706. In some examples, steps 704 and 706 may be performed exclusively, for example, step 704 may replace step 604 above or step 706 may replace step 606 above. In some examples, simultaneously encoding voice chat audio data for transmitting and performing a relevance analysis of the voice chat audio includes simultaneously encoding the entirety of the voice chat audio data and performing the entirety of the relevance analysis of the voice chat audio. In other examples, simultaneously encoding voice chat audio data for transmitting and performing a relevance analysis of the voice chat audio includes simultaneously encoding a portion of the voice chat audio data and performing a portion of the relevance analysis of the voice chat audio. At step 708, a control signal is generated based at least in part on the relevance analysis.

At step 710, the control signal and the encoded voice chat audio data are transmitted, by the first computing device and at a high priority, for reception by a second computing device of the plurality of computing devices. In some examples, step 710 may be performed exclusively, for example, step 710 may replace step 610 above. At step 712, the transmittal to the second computing device causes the second computing device to select, based on the control signal, a subset of the transmitted voice chat audio data and to output, based on the selected subset of the transmitted voice chat audio data, audio.

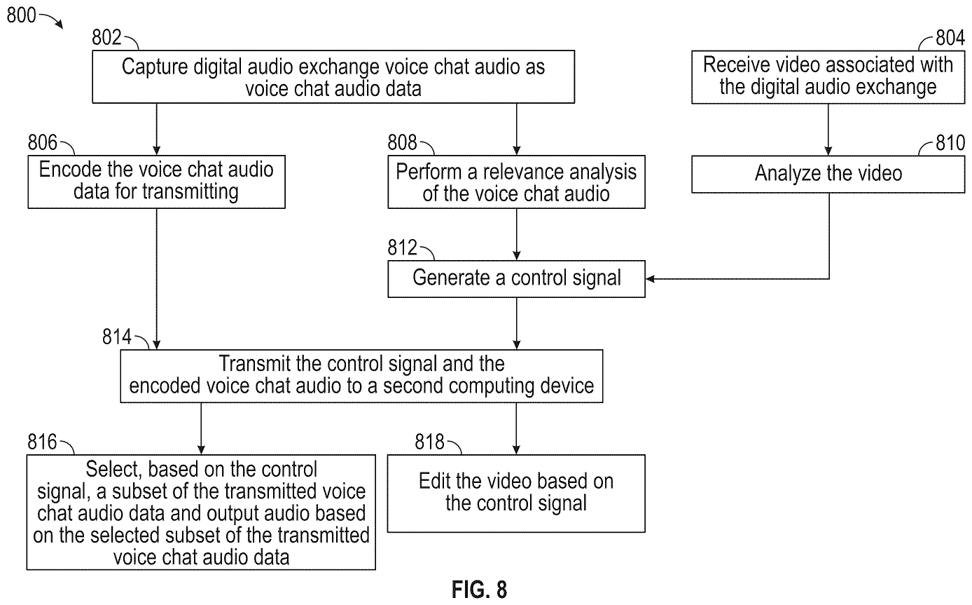

FIG. 8 is another flowchart of illustrative steps for enabling the improved transmission of audio in a digital audio exchange, in accordance with some embodiments of the disclosure. Process 800 may be implemented, in whole or in part, on any of the computing devices mentioned herein. In addition, one or more actions of the process 800 may be incorporated into or combined with one or more actions of any other processes or embodiments described herein.

At step 802, voice chat audio is captured as voice chat audio data, for example, at a first computing device of a plurality of computing devices participating in a digital audio exchange. At step 804, video associated with the digital audio exchange is received at the first computing device, for example, via an integral camera. At steps 806 and 808, the voice chat audio data is processed, including simultaneously encoding the voice chat audio data for transmitting at step 806, and performing a relevance analysis of the voice chat audio at step 808. In some examples, simultaneously encoding voice chat audio data for transmitting and performing a relevance analysis of the voice chat audio includes simultaneously encoding the entirety of the voice chat audio data and performing the entirety of the relevance analysis of the voice chat audio. In other examples, simultaneously encoding voice chat audio data for transmitting and performing a relevance analysis of the voice chat audio includes simultaneously encoding a portion of the voice chat audio data and performing a portion of the relevance analysis of the voice chat audio. At step 810, the video is analyzed and, at step 812, a control signal is generated based at least in part on the relevance analysis and the video analysis.

At step 814, the control signal and the encoded voice chat audio data are transmitted, by the first computing device, for reception by a second computing device of the plurality of computing devices. In some examples, the video is received at the second computing device from the first computing device (not shown). In other examples, the video is received at the second computing device via a server, for example, a server associated with a video conferencing service. At step 816, the transmittal to the second computing device causes the second computing device to select, based on the control signal, a subset of the transmitted voice chat audio data and to output, based on the selected subset of the transmitted voice chat audio data, audio. At 818, the video is optionally edited based on the control signal. For example, the video may be edited to show a participant as not talking when associated audio is muted or not played out at the second computing device based on an indication present in the control signal.

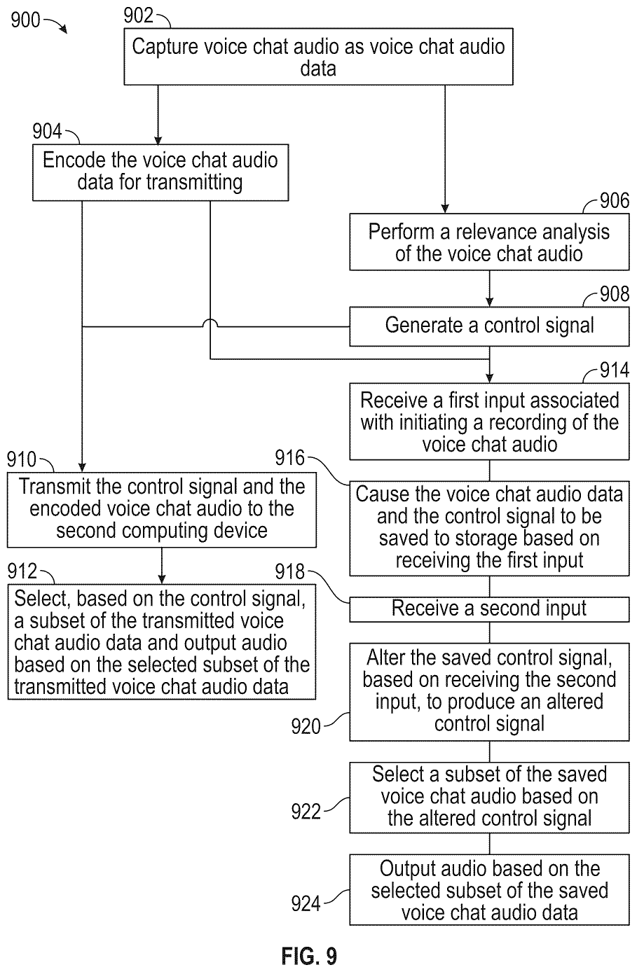

FIG. 9 is another flowchart of illustrative steps for enabling the improved transmission of audio in a digital audio exchange, in accordance with some embodiments of the disclosure. Process 900 may be implemented, in whole or in part, on any of the computing devices mentioned herein. In addition, one or more actions of the process 900 may be incorporated into or combined with one or more actions of any other processes or embodiments described herein.

At step 902, voice chat audio is captured as voice chat audio data, for example, at a first computing device of a plurality of computing devices participating in a digital audio exchange. At steps 904 and 906, the voice chat audio data is processed, including simultaneously encoding the voice chat audio data for transmitting at step 904, and performing a relevance analysis of the voice chat audio at step 906. In some examples, simultaneously encoding voice chat audio data for transmitting and performing a relevance analysis of the voice chat audio includes simultaneously encoding the entirety of the voice chat audio data and performing the entirety of the relevance analysis of the voice chat audio. In other examples, simultaneously encoding voice chat audio data for transmitting and performing a relevance analysis of the voice chat audio includes simultaneously encoding a portion of the voice chat audio data and performing a portion of the relevance analysis of the voice chat audio. At step 908, a control signal is generated based at least in part on the relevance analysis.

At step 910 the control signal and the encoded voice chat audio data are transmitted, by the first computing device, for reception by a second computing device of the plurality of computing devices. At step 912, the transmittal to the second computing device causes the second computing device to select, based on the control signal, a subset of the transmitted voice chat audio data and to output, based on the selected subset of the transmitted voice chat audio data, audio.

At step 914, a first input associated with initiating a recording of the digital audio exchange is received. In some examples, this first input may be the selection of a user interface element of a conference software that is configured to initiate the recording of the digital audio exchange. At step 916, the voice chat audio data and the control signal are saved to a storage based on receiving the first input. In some examples, this storage may be integral to the first computing device on which the audio is captured. In other examples, this storage may be storage of a server, such as a cloud server. At step 918, a second input is received. In some examples, this second input may be input associated with selecting a part of the audio to play or to not play, such as inverting a play or not play indication in the control signal. At step 920, the saved control signal is altered, based at least in part on the second input, to produce an altered control signal. At step 922, a subset of the saved voice chat audio data is selected based on the altered control signal, and at step 924, audio is output based on the selected subset of the saved voice chat audio data.

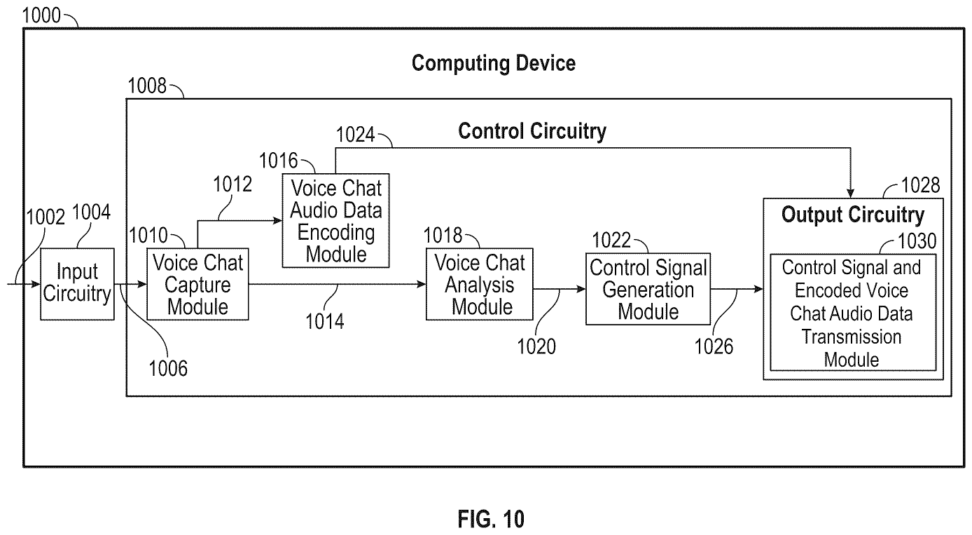

FIG. 10 is a block diagram representing components of a computing device and dataflow therebetween for enabling the improved transmission of audio in a digital audio exchange, in accordance with some embodiments of the disclosure. Computing device 1000 comprises input circuitry 1004, control circuitry 1008 and output circuitry 1028. The computing device 1000 may be, for example, a laptop. Control circuitry 1008 may be based on any suitable processing circuitry (not shown) and comprises control circuits and memory circuits, which may be disposed on a single integrated circuit or may be discrete components and processing circuitry. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors or processing units, for example, multiple of the same type of processing units (e.g., two Intel Core i9 processors) or multiple different processors (e.g., an Intel Core i5 processor and an Intel Core i7 processor) and/or a system on a chip (e.g., a Qualcomm Snapdragon 888). Some control circuits may be implemented in hardware, firmware, or software.

First input is received 1002 by the input circuitry 1004. The input circuitry 1004 is configured to receive inputs related to a computing device. For example, this input may be audio input via a microphone integral to the computing device. In some examples, this input may be received via a microphone external to the computing device and/or audio data via a secondary computing device. The input circuitry 1004 transmits 1006 the user input to the control circuitry 1008.

The control circuitry 1008 comprises a voice chat capture module 1010, a voice chat audio data encoding module 1016, a voice chat analysis module 1018, a control signal generation module 1022 and output circuitry 1028 comprising a control signal and encoded voice chat audio data transmission module 1030.

The first input is transmitted 1006 to the voice chat capture module 1010, where voice chat audio is captured as voice chat audio data. The voice chat audio data is simultaneously transmitted 1012, 1014 from the voice chat capture module 1010 to the voice chat audio data encoding module 1016 and the voice chat analysis module 1018. The voice chat audio data encoding module 1016 encodes the voice chat audio data for transmitting; for example, the voice chat audio data encoding module 1016 encodes and packetizes the voice chat audio data. Simultaneously, the voice chat analysis module 1018 performs a relevance analysis of the voice chat audio data, for example, to identify which audio data to play out at a secondary computing device and which audio data to not play out at the secondary computing device. An indication of the relevance analysis is transmitted 1020 to the control signal generation module 1022, where a control signal is generated based, at least in part, on the control signal. The encoded voice chat audio data and the control signal are transmitted 1024, 1026 to the output circuitry 1028, where the control signal and encoded voice chat audio data transmission module transmits the control signal and the encoded voice chat audio data for reception by a second computing device, to cause the second computing device to select, based on the control signal, a subset of the transmitted voice chat audio data and output, based on the selected subset of the transmitted voice chat audio data, audio.

The processes described above are intended to be illustrative and not limiting. One skilled in the art would appreciate that the steps of the processes discussed herein may be omitted, modified, combined, and/or rearranged, and any additional steps may be performed without departing from the scope of the disclosure. More generally, the above disclosure is meant to be illustrative and not limiting. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
capturing, at a first computing device of a plurality of computing devices participating in a digital audio exchange, voice chat audio as voice chat audio data;
processing the voice chat audio data, including simultaneously encoding the voice chat audio data for transmitting and performing a relevance analysis of the voice chat audio;
generating, based at least in part on the relevance analysis, a control signal; and
transmitting, by the first computing device, the control signal and the encoded voice chat audio data for reception by a second computing device of the plurality of computing devices, to cause the second computing device to:
select, based on the control signal, a subset of the transmitted voice chat audio data; and
output, based on the selected subset of the transmitted voice chat audio data, audio.

2. The method of claim 1, wherein processing the voice chat audio data comprises:
during a first time period, encoding a first portion of the voice chat audio data for transmitting;
during a second time period starting after the beginning of the first time period, simultaneously encoding a second portion of the voice chat audio data for transmitting and performing a first relevance analysis of a third portion of the voice chat audio; and
during a third time period starting after the end of the second time period, performing a second relevance analysis of a fourth portion of the voice chat audio.

3. The method of claim 1, wherein performing the relevance analysis of the voice chat audio comprises identifying a background sound and/or identifying that a first user participating in the digital audio exchange is conversing with a second user not participating in the digital audio exchange.

4. The method of claim 1, wherein:
processing the voice chat audio for transmitting comprises encoding and packetizing the voice chat audio to generate a plurality of audio packets; and
the control signal indicates a first subset of the plurality of audio packets to output and a second subset of the plurality of audio packets to discard.

5. The method of claim 1, wherein:
the method further comprises:
receiving, at the first computing device, video associated with the digital audio exchange; and
analyzing the video; and
generating the control signal further comprises generating the control signal based, at least in part, on the analyzing of the video.

6. The method of claim 5, wherein analyzing the video further comprises analyzing the video to identify a user that turns their head away from a capture device and/or changes their gaze from a normal position.

7. The method of claim 1, wherein transmitting the control signal and the encoded voice chat audio data comprises transmitting the control signal and the encoded voice chat audio data at a high priority.

8. The method of claim 1, wherein:
the control signal identifies a first part of the voice chat audio for output, a second part of the voice chat audio for discarding and a third part of unidentified voice chat audio; and
the method further comprises causing the second computing device to determine whether to output the third part of unidentified voice chat audio.

9. The method of claim 1, wherein the method further comprises transmitting, by the first computing device, video associated with the digital audio exchange for reception by the second computing device, to cause the second computing device to edit, based on the control signal, the transmitted video.

10. The method of claim 1, wherein the method further comprises:
receiving, at the first computing device, a first input associated with initiating a recording of the digital audio exchange;
based on receiving the first input, causing the voice chat audio data and the control signal to be saved to a storage;
receiving a second input;
altering the saved control signal, based at least in part on the second input, to produce an altered control signal;
selecting, based on the altered control signal, a subset of the saved voice chat audio data; and
outputting, based on the selected subset of the saved voice chat audio data, audio.

11. The method of claim 1, wherein:
the first computing device is a server;
receiving the voice chat audio comprises receiving the voice chat audio at the server from a first client computing device; and
the second computing device is a second client computing device.

12. A system comprising:
input/output circuitry configured to:
capture, at a first computing device of a plurality of computing devices participating in a digital audio exchange, voice chat audio as voice chat audio data; and
processing circuitry configured to:
process the voice chat audio data, including simultaneously encoding the voice chat audio data for transmitting and performing a relevance analysis of the voice chat audio;
generate, based at least in part on the relevance analysis, a control signal; and
transmit, by the first computing device, the control signal and the encoded voice chat audio data for reception by a second computing device of the plurality of computing devices, to cause the second computing device to:
select, based on the control signal, a subset of the transmitted voice chat audio data; and
output, based on the selected subset of the transmitted voice chat audio data, audio.

13. The system of claim 12, wherein the processing circuitry configured to process the voice chat audio data is configured to:
during a first time period, encode a first portion of the voice chat audio data for transmitting;
during a second time period starting after the beginning of the first time period, simultaneously encode a second portion of the voice chat audio data for transmitting and perform a first relevance analysis of a third portion of the voice chat audio; and
during a third time period starting after the end of the second time period, perform a second relevance analysis of a fourth portion of the voice chat audio.

14. The system of claim 12, wherein the processing circuitry configured to perform the relevance analysis of the voice chat audio is configured to identify a background sound and/or identify that a first user participating in the digital audio exchange is conversing with a second user not participating in the digital audio exchange.

15. The system of claim 12, wherein:
the processing circuitry configured to process the voice chat audio for transmitting is configured to encode and packetize the voice chat audio to generate a plurality of audio packets; and
the control signal indicates a first subset of the plurality of audio packets to output and a second subset of the plurality of audio packets to discard.

16. The system of claim 12, wherein:
the system further comprises processing circuitry configured to:
receive, at the first computing device, video associated with the digital audio exchange; and
analyze the video; and
the processing circuitry configured to generate the control signal is further configured to generate the control signal based, at least in part, on the analyzing of the video.

17. The system of claim 16, wherein the processing circuitry configured to analyze the video is further configured to analyze the video to identify a user that turns their head away from a capture device and/or changes their gaze from a normal position.

18. The system of claim 12, wherein the processing circuitry configured to transmit the control signal and the encoded voice chat audio data is configured to transmit the control signal and the encoded voice chat audio data at a high priority.

19. The system of claim 12, wherein:
the control signal identifies a first part of the voice chat audio for output, a second part of the voice chat audio for discarding and a third part of unidentified voice chat audio; and
the system further comprises processing circuitry configured to cause the second computing device to determine whether to output the third part of unidentified voice chat audio.

20. The system of claim 12, wherein the system further comprises processing circuitry configured to transmit, by the first computing device, video associated with the digital audio exchange for reception by the second computing device, to cause the second computing device to edit, based on the control signal, the transmitted video.

21-55. (canceled)
